(19) United States
(12) Patent Application Publication
(10) Pub. No.: US 2007/0223507 A1
(43) Pub. Date: Sep. 27, 2007

(54) COMMUNICATION DEVICE AND METHOD FOR AUTOMATICALLY SWITCHING CHANNELS

(75) Inventor: CHU-FENG LIEN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,639

(22) Filed: Sep. 1, 2006

(30) Foreign Application Priority Data
Mar. 22, 2006 (CN) 200610060003.X

(51) Int. Cl. H04L 12/28

(52) U.S. Cl. 370/431; 370/465

(57) ABSTRACT

A communication device (20) for automatically switching channels, includes a transceiver module (200), a database (230), a channel determining module (210), and a channel switching module (220). The transceiver module is used for receiving an outside message including a communication field. The database is used for saving communication channel data. The channel determining module is used for determining whether a communication channel indicated by the communication field of the outside message matches a communication channel of the communication device. The channel switching module is used for switching the communication channel of the communication device and saving the switched communication channel data in the database, when the communication channel indicated by the communication field of the outside message does not match the communication channel of the communication device.

### 1. FIELD OF THE INVENTION

The invention relates to communication device, and particularly to a communication device for automatically switching channels.

### 2. DESCRIPTION OF RELATED ART

In the V5.2 protocol, there are a communication channel and a protection channel. The communication channel is a logic channel changing with service states of the physical layer, and controls communications between an access network (AN) and a local exchange (LE). The protection channel is a logic channel for protecting the communication channel. If the communication channel is abnormal, the protection channel takes over communications from the communication channel. There are more than two physical links between the AN and the LE. In an initial operation, the communication channel is on a first physical link, and the protection channel is on a second physical link.

When there is an error, for example, the physical layer is interrupted, the LE sends a switch-over command to the AN, to make the AN switch communications from the first physical link to the second physical link. The AN receives the switch-over command, switches the communication channel from the first physical link to the second physical link, and sends a switch-over acknowledgement (ACK) message to the LE. If the LE receives the ACK message, the channels between the LE and the AN matches, and the LE communicates with the AN on the second physical link. However, if the LE does not receive the ACK message, the channels between the LE and the AN do not matched, the communication between the LE and the AN would be failure.

### SUMMARY OF THE INVENTION

An embodiment of the invention provides a communication device for automatically switching channels. The communication device includes a transceiver module, a database, a determining channel module, and a switching channel module. The transceiver module is used for receiving an outside message including a communication field. The database is used for saving communication channel data. The channel determining module is used for determining whether a communication channel indicated by the communication field of the outside message matches with a communication channel of the communication device. The channel switching module is used for switching the communication channel of the communication device and saving the switched communication channel data in the database, when the communication channel indicated by the communication field of the outside message does not match the communication channel of the communication device.

Another embodiment of the invention provides a method for automatically switching channels. The method includes receiving an outside message including a communication field, determining whether a communication channel indicated by the communication field of the outside message matches with a current communication channel of the communication device, if not, switching the current communication channel of the communication device to the communication channel of the outside message, and saving the switched communication channel data in a database.

Other advantages and novel features will become more apparent from the following detailed description when taken in conjunction with the accompanying drawings, in which:

### BRIEF DESCRIPTION OF THE DRAWINGS

FIG. 1 shows a block diagram of a communication device; and

FIG. 2 shows a flow chart of a method for automatically switching channels.

### DETAILED DESCRIPTION OF THE INVENTION

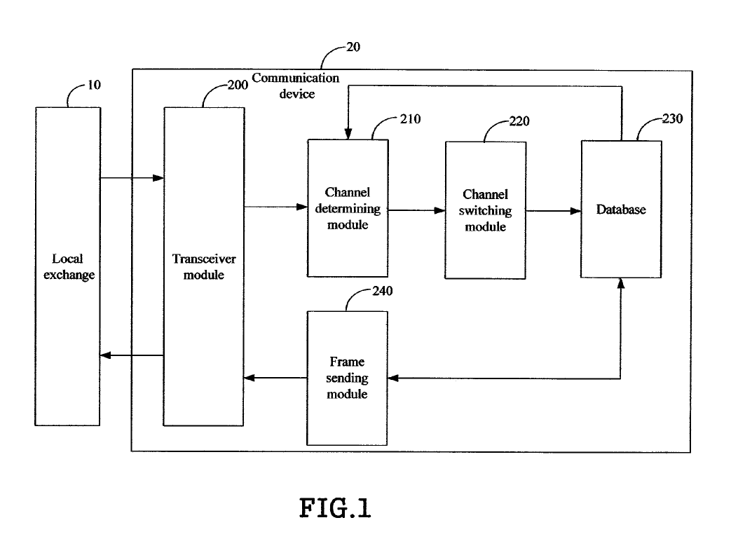

FIG. 1 is a block diagram of a communication device 20 for automatically switching channels in accordance with an exemplary embodiment of the invention. In this exemplary embodiment, the communication device 20 is connected to a local exchange (LE) 10. The communication device 20 may be an access network device. The communication device 20 includes a transceiver module 200, a channel determining module 210, a channel switching module 220, a database 230, and a frame sending module 240. In this exemplary embodiment, the transceiver module 200 is connected to the LE 10 for receiving an outside message from the LE 10, and includes a plurality of communication channels. In this exemplary embodiment, the outside message includes a communication field, and the communication field indicates a communication channel. In this exemplary embodiment, the transceiver module 200 is also used for decoding the outside message, and sending the decoded outside message to the channel determining module 210.

The database 230 is connected to the channel determining module 210, the channel switching module 220, and the frame sending module 240, and is used for saving communication channel data of the communication device 20. In this exemplary embodiment, the communication channel of the communication device 20 is a communication channel for sending messages.

The channel determining module 210 is connected to the transceiver module 200, the channel switching module 220, and the database 230, and is used for determining whether the communication channel indicated by the communication field of the outside message matches with the communication channel of the communication device 20. In this exemplary embodiment, the communication channel indicated by the communication field of the outside message, that is the communication channel of the outside message, is the communication channel that the LE 10 sends the outside message. The channel determining module 210 receives the decoded outside message from the transceiver module 200, parses the communication field of the outside message to identify the communication channel of the outside message, and queries the database 230 to identify the communication channel of the communication module 20. If the communication channel indicated by the communication field of the outside message matches the communication channel of the communication device 20, there is no need to switch the communication channel, and the communication device 20 can send messages to the LE 10 via the communication channel of the communication device 20. If the communication channel indicated by the communication field of the outside message does not match the communication channel of the communication device 20, the channel determining module 210 generates a switching signal, and sends the switching signal to the channel switching module 220.

The channel switching module 220 is connected to the channel determining module 210 and the database 230, and is used for switching the communication channel of the communication device 20 and saving the switched communication channel data in the database 20, when the communication channel indicated by the communication field of the outside message does not match the communication channel of the communication device 20. In this exemplary embodiment, the frame sending module 240 is connected to the database 230 and the transceiver module 200, and is used for querying the database 230 to retrieve the communication channel data, and sending a frame to a corresponding communication channel of the transceiver module 200 according to the retrieved communication channel data. In this exemplary embodiment, the frame is a communication message between the communication device 20 and the LE 10. In this exemplary embodiment, the transceiver module 200 receives the frame sent by the frame sending module 240, and sends the frame to the LE 10 via the corresponding communication channel.

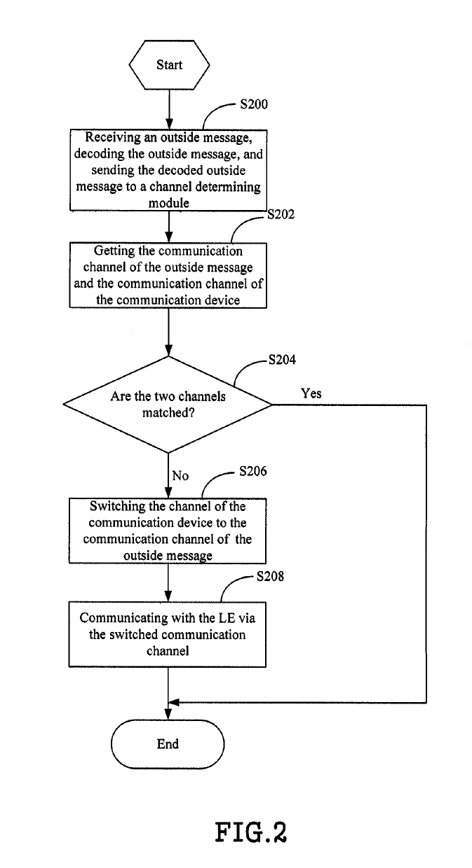

FIG. 2 is a flow chart of a method for automatically switching channels in accordance with an exemplary embodiment of the invention. In step S200, the transceiver module 200 receives an outside message, decodes the outside message, and sends the decoded outside message to the channel determining module 210. In this exemplary embodiment, the outside message includes a communication field indicating a communication channel. In step S202, the channel determining module 210 identifies the communication channel of the outside message and the communication channel of the communication device 20. In this exemplary embodiment, the channel determining module 210 parses the communication field of the outside message to identify the communication channel of the outside message, and queries the database 230 to identify the communication channel of the communication module 20.

In step S204, the channel determining module 210 determines whether the communication channel of the outside message matches the communication channel of the communication device 20. If the communication channel of the outside message matches the communication channel of the communication device 20, the flow ends, and the communication device 20 communicates with the LE 10 via a current communication channel. In step S206, if the communication channel indicated by the communication field of the outside message does not match the communication channel of the communication device 20, the channel switching module 220 switches the communication channel of the communication device 20 to the communication channel of the outside message.

In step S208, the communication device 20 communicates with the LE 10 via the switched communication channel. The frame sending module 240 queries the database 230 to retrieve the communication channel data, and sends a frame to a corresponding communication channel of the transceiver module 200 according to the retrieved communication channel data. In this exemplary embodiment, the transceiver module 200 receives the frame, and sends the frame to the LE 10 via the corresponding communication channel.

The communication device 20 and the method for automatically switching channels ensures normal communication between the LE 10 and the communication device 20, thereby avoiding communication failure between the LE 10 and the communication device 20 when the channels between the LE 10 and the communication device 20 do not match.

It is believed that the present embodiments and their advantages will be understood from the foregoing description, and it will be apparent that various changes may be made thereto without departing from the spirit and scope of the invention or sacrificing all of its material advantages, the examples hereinbefore described merely being exemplary or exemplary embodiments.

What is claimed is:

1. A communication device for automatically switching channels, comprising:
a transceiver module for receiving an outside message comprising a communication field;
a database for saving communication channel data of the communication device;
a channel determining module for determining whether a communication channel indicated by the communication field of the outside message matches a communication channel of the communication device; and
a channel switching module for switching the communication channel of the communication device and saving switched communication channel data in the database, when the communication channel indicated by the communication field of the outside message does not match the communication channel of the communication device.

2. The communication device of claim 1, wherein the channel determining module queries the database to identify a communication channel data of the communication device.

3. The communication device of claim 1, wherein the transceiver module comprises a plurality of communication channels.

4. The communication device of claim 3, wherein the communication device further comprises a frame sending module for querying the database to retrieve the communication channel data, and sending a frame to a corresponding communication channel of the transceiver module according to the retrieved communication channel data.

5. The communication device of claim 1, wherein the transceiver module is further for decoding the outside message and sending the decoded outside message to the channel determining module.

6. The communication device of claim 5, wherein the channel determining module is further for parsing the communication field of the outside message to identify the communication channel of the communication device.

7. The communication device of claim 6, wherein the channel determining module is further for sending a switching channel signal to the channel switching module, when the communication channel indicated by the communication field of the outside message does not match the communication channel of the communication device.

8. The communication device of claim 1, wherein the communication device is an access network device.

9. A method for automatically switching channels, comprising:
receiving an outside message comprising a communication field;
determining whether a communication channel indicated by the communication field of the outside message matches a current communication channel of a communication device; and
if not, switching the current communication channel of the communication device to the communication channel indicated by the communication field of the outside message, and saving the switched communication channel data in a database.

10. The method for automatically switching channels of claim 9, further comprising:
communicating with a local exchange (LE) via the current communication channel, if the communication channel indicated by the communication field of the outside message matches the communication channel of the communication device.

11. The method for automatically switching channels of claim 9, wherein the communication device is an access network device.

12. The method for automatically switching channels of claim 9, further comprising decoding the outside message.

13. The method for automatically switching channels of claim 9, wherein the step of determining whether a communication channel indicated by the communication field of the outside message matches the current communication channel of a communication device comprises:
parsing the communication field of the outside message to identify the communication channel of the outside message; and
querying the database to identify the communication channel of the communication device.

14. The method for automatically switching channels of claim 9, wherein the communication channel of the communication device is used for sending communication messages.

15. The method for automatically switching channels of claim 9, further comprising:
querying the database to retrieve a communication channel data, and sending a frame to a corresponding communication channel of a transceiver module according to the communication channel data; and
receiving the frame, and sending the frame to the LE via the corresponding communication channel.

16. A method for automatically switching channels, comprising:
establishing message-communication between a communication device and a local exchange (LE) via at least two communication channels;
message-communicating said communication device with said LE through a predetermined current communication channel out of said at least two channels;
retrieving a message from said LE;
verifying a message-indicating communication channel out of said at least two channels by means of parsing said message; and
switching said current communication channel to said verified message-indicating communication channel when said current communication channel does not match said verified message-indicating communication channel.
